(19) United States
(12) Patent Application Publication
(10) Pub. No.: US 2016/0043357 A1
(43) Pub. Date: Feb. 11, 2016

(54) PORTABLE POWER SUPPLY

(71) Applicant: Dark Energy, LLC, Provo, UT (US)

(72) Inventors: Garrett Aida, Provo, UT (US); Michael Anderson, Springville, UT (US); John Omdahl, Lindon, UT (US); Michael Horito, Provo, UT (US)

(21) Appl. No.: 14/816,454

(22) Filed: Aug. 3, 2015

Related U.S. Application Data
(60) Provisional application No. 62/033,447, filed on Aug. 5, 2014.

(51) Int. Cl. H01M 2/02; H01M 2/06; H02J 7/00

(52) U.S. Cl. CPC H01M 2/026; H02J 7/0054; H01M 2/0202; H01M 2/0267; H01M 2/0292; H01M 2/06; H02J 2007/0062; H01M 10/4257

(57) ABSTRACT

A portable power supply may include housing and an elastomeric material disposed about the periphery of the housing to minimize damage to the housing if it is dropped or comes into contact with liquids or other contaminants. The elastomeric material may be formed in a single piece and may also form a door for selectively closing ports in the power supply.

### BACKGROUND OF THE INVENTION

1. The Field of the Invention

The present invention relates to a portable power supply. More specifically, the present invention relates to a portable power supply having improved casing to minimize damage to the portable power supply caused by drops or environmental factors.

2. State of the Art

Over the past two decades there has been a marked increase in the use of portable electronic devices. Most people carry a cellular telephone. In addition, there are a wide variety of portable electronic devices including, but not limited to, smartphones, two-way radios, rangefinders, video recording devices, wireless headsets, portable internet hotspots, portable gaming devices, tablet computers, GPS units, electronic cameras and MP3 players. All of these devices require electricity and it is common to see people crowded around power outlets at airports and other public venues as they attempt to charge a device which has run out or is running out of power. Additionally, many people need power to charge devices when they are away from outlets, such as out of doors.

Because of the expanding use of portable electronics, there has also been an increase in the use of portable power supplies. Many portable power supplies include a battery and at least one power port. For many portable electronic devices, the power is supplied via a Universal Serial Bus (USB) port. A USB cable is used to connect the electronic device to the portable power supply. The portable power supply will typically include a battery which has a higher storage capacity than the battery of an individual portable electronic device. Thus, the portable power supply can recharge a cellular telephone, a tablet computer, etc., several times on a single charge of the portable power supply. Thus a person carrying a portable power supply can recharge one or more devices several times without having to find and remain by a conventional electrical outlet. Other types of portable power supplies may only include a small battery that provides a single charge and is easier to carry at all times.

One problem which is common with portable power supplies is damage to the power supply. As with portable electronic devices, portable power supplies are usually carried in a variety of scenarios. Some people use portable power supplies for travel, where the power supply is subject to damage from being bumped, dropped, etc. Other people use portable power supplies so that they can use portable electronic devices in remote locations, such as when hunting, camping, fishing, etc., where the power supply may be subject to damage from water and other environmental factors. Still others use portable power supplies while at locations which may lack electricity, such as at a construction site. In all of these environments, the portable power supply may be damaged by being dropped on hard surfaces, dropped in water or mud, having liquids spilled thereon, being sat on, etc.

Because portable power supplies are not inexpensive, damaging the portable power supply is highly undesirable. Thus, there is a need for a rugged portable power supply which is less susceptible to damage due to being dropped or from other environmental factors.

### SUMMARY OF THE INVENTION

It is an object of the present invention to provide an improved portable power supply.

In accordance with one aspect of the present disclosure, the portable power supply includes a housing having an upper portion and a lower portion, both the upper portion and lower portion being made from a generally rigid material, and an elastomeric material around a portion of the housing. The elastomeric material may be used to improve the ability of the portable power supply to survive being dropped without being damaged.

In accordance with another aspect of the present disclosure the elastomeric material may include a plurality of projections which extend outwardly from the housing. The projections may be disposed at corners of the housing and may have one or more flattened sections to engage a surface if the portable power supply is dropped.

In accordance with another aspect of the present disclosure, the elastomeric material may be made of a single piece and form a seal about the exterior of the housing. The elastomeric material may have a relatively simple cross-section while still forming a tortuous path for inhibiting the ingress of water, etc., or it may have a plurality of flanges or projections to provide an improved barrier to liquids entering the housing.

In accordance with another aspect of the present disclosure, the elastomeric material also forms a cover for selectively closing the power ports on the portable power supply. In some configurations, the elastomeric material also forms a cover for collectively closing all the power ports on the portable power supply. In some configurations, a hard plastic pin joint door may be used for selectively or collectively closing the power ports on the portable power supply.

In accordance with still another aspect of the present disclosure, some or all of the electronic components of the portable power supply may be coated to prevent damage to the components in the event that water enters the housing.

In accordance with still another aspect of the present disclosure, the housing may include separate chambers for holding the battery and the electronics so that water passing into the electronics does not enter the battery chamber and cause corrosion or other types of damage. In some configurations, multiple chambers may be used, and in other configurations a single chamber may be used.

In accordance with still another aspect of the disclosure, the upper portion and the lower portion of the housing may be ultrasonically sealed to one other. Other methods of connecting the upper portion and the lower portion of the housing may be used, for example, by snap-fit connections, etc. In some configurations, a gasket may be used between the upper portion and lower portion to provide a better seal and increase shock absorption. Other structures such as projections on one portion that interact with recesses on another portion may also assist in damping.

In accordance with still another aspect of the present disclosure, the leads extending from the battery to the circuitry may help form a seal between the battery chamber and the circuitry chamber when a configuration with multiple chambers is used.

In accordance with still another aspect of the present disclosure, the leads may be formed from an anti-corrosive material which suffers minimum corrosion when immersed in water.

In accordance with still another aspect of the present disclosure, the elastomeric material may have a hole formed therethrough for receiving a fastener. In some configurations, the projections may have a hole formed therethrough for receiving a fastener.

In accordance with still another aspect of the present disclosure the circuitry may be disposed on a circuit board which is engaged by a damping mechanism for reducing the transfer of vibrational energy.

In accordance with another aspect of the invention, holes extending between two chambers for conveying electricity from the battery to the electronics may be sealed by a coating on the wire or by a grommet or other similar structure.

While the present disclosure identifies numerous aspects which may be included in the portable power supply, it will be appreciated that some or all of these aspects may be omitted and that the scope of the invention is intended to be measured by the appended claims.

### BRIEF DESCRIPTION OF THE DRAWINGS

Various embodiments of the present invention are shown and described in reference to the numbered drawings wherein:

FIG. 1A shows a top perspective view of a portable power supply made in accordance with the principles of the present disclosure;

FIG. 1B shows a bottom perspective view of the portable power supply of FIG. 1;

FIG. 2 shows a plan view of the portable power supply with the upper portion removed so as to expose the circuitry, the battery, and the elastomeric material disposed on the lower portion;

FIG. 3 shows a cross-sectional view of the portable power supply taken along the line 3-3 of FIG. 1 through the battery portion of the portable power supply;

FIG. 3A shows a close-up cross-sectional view of the elastomeric material and edge of the housing of FIG. 3;

FIG. 4 shows a cross-sectional view of the portable power supply taken along the line 4-4 of FIG. 1 through the circuitry portion of the portable power supply;

FIG. 4A shows a close-up cross-sectional view of the elastomeric material forming the power button;

FIG. 5 shows a side cross-sectional view taken along the line 5-5 of FIG. 1;

FIG. 6 shows a close-up view of one embodiment of the circuit board and mounting structure disposed in the housing;

FIG. 7 shows an alternate configuration of the door used for closing the power ports in the housing;

FIG. 8 shows yet another alternate configuration of the door used for closing the power ports in the housing;

FIG. 9 shows a plan view of another configuration of the lower portion of the housing of the power supply with the elastomeric material;

FIG. 10 shows a plan view of another configuration of upper portion of the housing of the power supply with the elastomeric material;

FIG. 11 shows a plan view of the housing of the power supply;

FIG. 11A shows a side cross-sectional view taken along the line A-A of FIG. 11;

FIG. 11B shows a side cross-sectional view taken along the line B-B of FIG. 11 showing the snap-fit connection; and

FIG. 11C shows a close-up cross-sectional view of the power button.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention and elements described herein should not be read into the claims except as specifically discussed therein.

### DETAILED DESCRIPTION

The following description includes various representative embodiments and specific details in order to provide a thorough understanding of the present disclosure. The skilled artisan will understand, however, that the methods and devices described below can be practiced without employing these specific details, or that they can be used for purposes other than those described herein. Indeed, they can be modified and can be used in conjunction with products and techniques known to those of skill in the art in light of the present disclosure.

Reference in the specification to “one configuration,” “one embodiment” “one aspect” or “a configuration,” “an embodiment” or “an aspect” means that a particular feature, structure, or characteristic described in connection with the configuration may be included in at least one configuration and not that any particular configuration is required to have a particular feature, structure or characteristic described herein. The appearances of the phrase “in one embodiment” or similar phrases in various places in the specification are not necessarily all referring to the same configuration, and may not necessarily limit the inclusion of a particular element of the invention to a single configuration, rather the element may be included in other or all configurations discussed herein. Thus it will be appreciated that the claims are not intended to be limited by the representative configurations shown herein. Rather, the various representative configurations are simply provided to help one of ordinary skill in the art to practice the inventive concepts claimed herein.

The invention and accompanying drawings will now be discussed in reference to the numerals provided therein so as to enable one skilled in the art to practice the present invention. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Furthermore, the described features, structures, or characteristics of configurations of the invention may be combined in any suitable manner in one or more configurations. In the following description, numerous specific details are provided, such as examples of products or manufacturing techniques that may be used, to provide a thorough understanding of configurations of the invention. One skilled in the relevant art will recognize, however, that configurations or embodiments of the present disclosure may be practiced without one or more of the specific details, or with other methods, components, materials, and so forth. In other instances, well-known structures, materials, or operations are not shown or described in detail to avoid obscuring aspects of the invention.

Prior to discussing particular configurations, it should be understood that the present invention is not limited to any particular structures, process steps, or materials discussed or disclosed herein, but is extended to include equivalents thereof as would be recognized by those of ordinary skill in the relevant art. More specifically, the invention is defined by the terms set forth in the claims. It should also be understood that terminology contained herein is used for the purpose of describing particular aspects of the invention only and is not intended to limit the invention to the aspects or configurations shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a spring” or “a damping mechanism” may include one or more of such springs or damping mechanisms, and reference to “the layer” may include reference to one or more of such layers.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

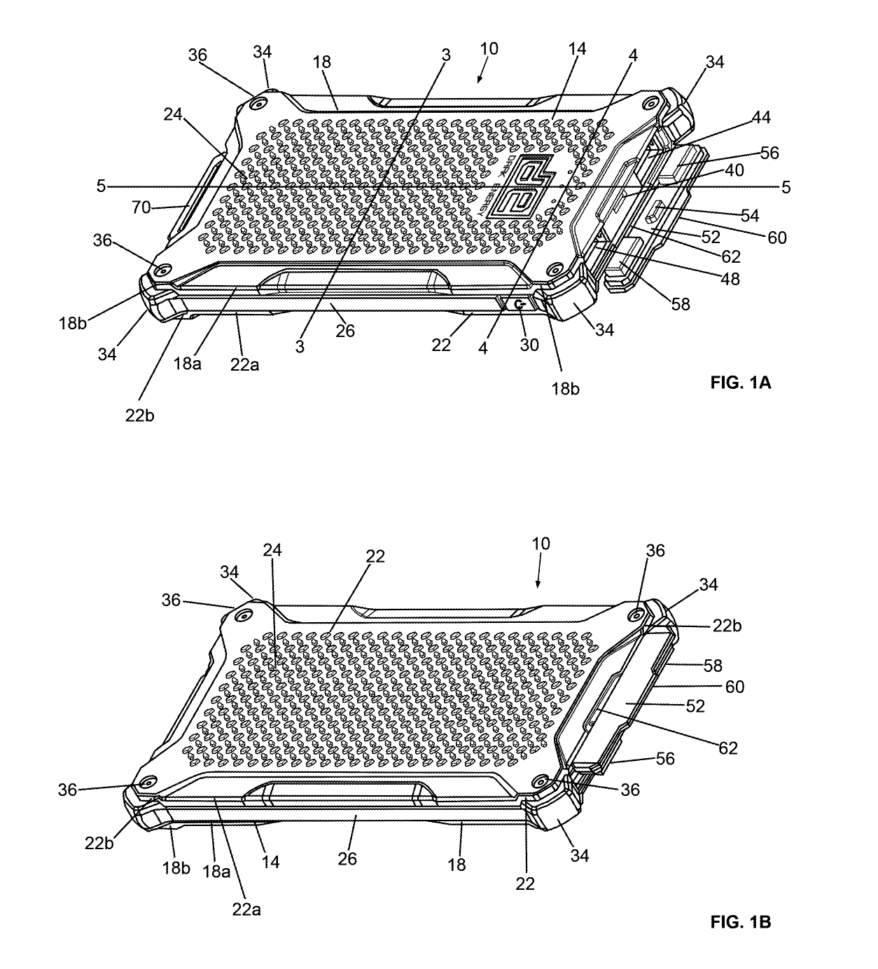

Turning now to FIG. 1, there is shown a perspective view of a portable power supply, generally indicated at 10. The portable power supply 10 includes a housing 14 having an upper wall or upper portion 18 and a lower wall or lower portion 22. The upper portion 18 and the lower portion 22 may be attached to each other in a variety of ways. For example, as will be discussed in additional detail below, the upper portion 18 and the lower portion 22 may be ultrasonically welded together. Other attachment mechanisms may be used, such as by connection with snap-fit as discussed below. The upper portion 18 and the lower portion 22 may be made from a variety of generally rigid materials, such as polycarbonate acrylonitrile butadiene styrene (PCABS). By generally rigid it is meant that the material is resistant to flexing, not that the material will not flex at all. Other generally rigid materials may also be used. The upper and lower portions 18, 22 may also be smooth, or may include a tactile surface 24 for promoting grip on the housing 14 to reduce the risk of the portable power supply being dropped.

Disposed peripherally about the housing 14 is an elastomeric material 26. The elastomeric material 26 may be made from several pieces. However, it is currently anticipated that the elastomeric material may be formed as a single piece. This provides a number of benefits as will be discussed below. The elastomeric material 26 may be made from a variety of elastomeric materials, such as thermoplastic elastomer, which provide damping to impact or vibrational energy.

The elastomeric material 26 may be sized such that some of the elastomeric material extends inwardly from the peripheral edges 18a and 22a of the upper portion 18 and the lower portion 22 respectively, and such that the elastomeric material extends outwardly beyond the peripheral edges of the upper portion and the lower portion. For example, along the sides and ends of the housing 14, the elastomeric material 26 may extend, for example, between 1/32 and ¼ inches (0.079 to 0.635 cm) beyond the peripheral edges 18a, 22a of the upper potion 18 and the lower portion 22.

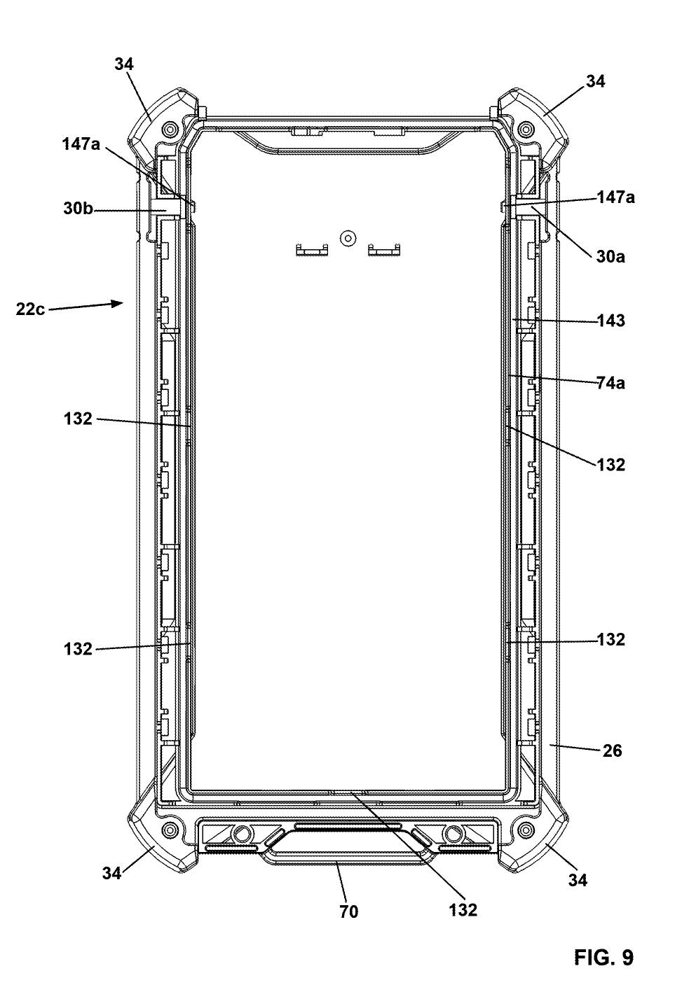

As shown in FIG. 1, the elastomeric material 26 may also be formed to define a power button 30 which extends beyond the peripheral edges 18a, 22a of the upper portion 18 and lower portion 22, respectively. The elastomeric material 26 will deform when pushed so that interior structures engage the power supply (not shown) to thereby activate or turn off the portable power supply 10. Other configurations, as discussed below, may be used, such as multiple buttons for different actuation (see discussion of FIG. 9 below).

The elastomeric material 26 extending beyond the periphery of the upper portion 18 and the lower portion 22 and extending inwardly beyond the periphery provides a desirable damping mechanism for absorbing shocks in the event that the portable power supply 10 is dropped. If the portable power supply 10 is dropped on the upper portion 18 or the lower portion 22, little damage is likely to be done. However, when a portable power supply 10 is dropped and lands on the ends or sides, the impact will often damage the upper portion and/or lower portion of a case. By using the elastomeric material 26 about the middle portion of the portable power supply 10, impacts on the ends or sides engage the elastomeric material 26 and the risk that the upper portion 18 or lower portion 22 will be damaged is significantly reduced.

Perhaps the most susceptible place to damage due to being dropped is the corners of the housing 14. If an unprotected corner hits floor, etc., it is common for an upper portion and/or lower portion to crack. It has been found, however, that using a projection 34 at the corner reduces the likelihood of the housing 14 being damaged due to a drop on a hard surface. Moreover, in the configuration shown, the projection 34 is approximately 1.5 to 3 times the width of the elastomeric material 26 along the sides of the housing 14. Thus, additional damping is provided in the event that the portable power supply 10 is dropped on a corner.

Additionally, the portion of the elastomeric material 26 forming the projections 34 may also be thicker (⅓ to ⅕ inches, 0.847-1.27 cm) than the elastomeric material disposed along the sides (⅕ to ⅓ inches, 0.508-0.847 cm). As shown in FIGS. 1A and 1B, the upper portion 18 and the lower portion 22 may each includes raised portions 18b and 22b, respectively, adjacent the corners so that the distance between the peripheral edge 18a of the upper portion 18 and the peripheral edge 22a of the lower portion 22 are spaced apart a greater distance at the corners than along the sides or ends.

FIGS. 1A and 1B also show a plurality of fasteners 36 which may extend through the projections 34. The fasteners 36 may be screws, rivets or the like, and may be used to hold the upper portion 18 to the lower portion 22, or may simply be for cosmetic purposes.

The perspective view of FIG. 1A also shows the access receptacles or ports 40, 44 and 48 of the portable power supply 10. The portable power supply 10 may include, for example, a receptacle or port 40 designed to receive a USB plug, such as a USB-mini or USB-micro, which is used to the charge the battery (not shown in FIG. 1) of the portable power supply 10. In use a USB-micro plug of a UBS cable is disposed in the receptacle or port 40 and the USB plug on the other end is disposed in a USB port on a computer, wall outlet, etc. Power flowing through the USB cable is stored in the battery for later use.

The portable power supply 10 may also include a pair of standard USB receptacles or ports 44 and 48 (which may run protocols 1.0, 2.0, 3.0, etc.) into which a standard USB plug of a USB cable is selectively disposed. The opposing end of the cable may include a USB-mini, USB-micro or other configuration of a plug for disposition in an electronic device to be charged or otherwise run from the portable power supply. By providing two standard USB ports, the portable power supply 10 can power two different devices at the same time. In other configurations, more USB ports may be provided by the portable power supply.

FIGS. 1A and 1B also show a door 52 for selectively closing the ports or receptacles 40, 44, 48 in the portable power supply 10. The door 52 may thus include a plurality of protrusions 54, 56 and 58 which nest in the receptacles 40, 44 and 48 to provide a seal against contaminants entering the receptacles. The door 52 may also form a projection 60 which facilitates moving the door into the open position shown in FIGS. 1A and 1B.

As shown in FIGS. 1A and 1B, the door 52 may be formed from the elastomeric material 26 so that the door provides additional damping against impact to the housing 14 in the event the housing 14 is dropped. Additionally, the door 52 and the remainder of the elastomeric material 26 may be formed as a single piece, thereby decreasing assembly costs and simplifying construction of the portable power supply 10. According to another configuration described below, the door may also be formed of any other suitable type of material, such as a hard plastic door with a pin joint hinge, for example.

To allow the door 52 to move from an open position shown in FIGS. 1A and 1B to a closed position, a portion of the elastomeric material 26 forms a compliant hinge 62 about which the remainder of the door 52 can pivot. While shown as extending along a portion of the length of the door 52, the compliant hinge 62 could extend along the length of the door or could be disposed at either end of the door 52 perpendicular to the long axis. Additionally, a single piece of elastomeric material could be used to make two or more doors so that the receptacles 40, 44 and 48 could be individually opened or covered. It will be appreciated that when an electronic device is being charged, the USB plug from its cable will be disposed in one of the ports 44 or 48 and will thus provide some protection to that port. With individual doors the other two ports could be closed, thereby preventing a spilled beverage, etc., from entering in to the receptacle. Additionally, it would lengthen the life of the hinge as the door would only be opened when that particular receptacle is needed.

The leads of the USB receptacles 40, 44 or 48 may be made from a corrosion resistant alloy or may be plated/coated with the corrosion resistant coatings such as gold, nickel, tin or zinc. It will be appreciated that while in use one or more of the receptacles 40, 44 or 48 may be exposed while powering a device or while the portable power supply 10 is being recharged. In the event that the portable power supply 10 was dropped in water, etc., during such a situation, the corrosion resistance could prevent the power supply from being damaged.

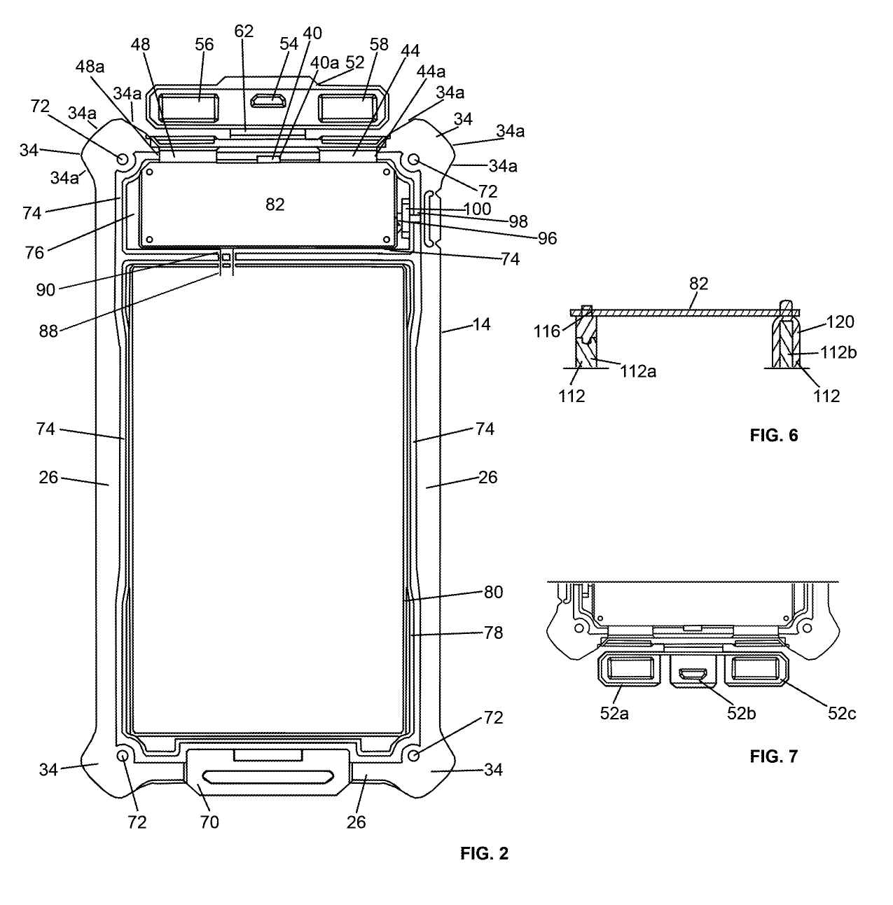

Turning now to FIG. 2, there is shown a plan view of the portable power supply of claim 10. The lower portion 22 is surrounded about its periphery by the elastomeric material 26. The elastomeric material 26 may have a first width (e.g. ⅛ to ¼ inches, 0.3175-0.635 cm, or 1/16 to ¼ inches, 0.158-0.635 cm), along the sides of the lower portion and a second, greater width at the projections 34 (e.g. ¼ to ½ inches, 0.635-1.27 cm, or ¼ to ¾ inches, 0.635-1.9 cm) at each corner. At the ends, the elastomeric material 26 may be of the same thickness as the sides, or may be contoured to hold structures, such as a retaining loop 70 by which the portable power supply 10 can be attached to a back pack or other carrying device. Retaining loop 70 may be formed of any suitable material, and may also be formed integrally with the elastomeric material 26 and/or housing 14 such that the retaining loop is an extension of the elastomeric material 26 and/or housing 14.

The projections 34 may be round, or as shown in FIG. 2, they may have flattened curvatures or generally flat faces 34a. It is believed that the three generally flat faces 34a on each projection help protect the corners of the housing 14 against damage in the event of a drop by providing broad surface areas for impact. Additionally, the projections 34 may have holes or voids 72 formed therein. The voids 72 may be used in combination with the elastomeric material 26 for damping purposes, and/or may be used to receive a fastener, such as fastener 36 discussed above.

FIG. 2 also provides a good view of the door 52 and the protrusions 54, 56 and 58 which nest in the USB or other power receptacles 40, 44 and 48 in the end of the housing 14. The compliant hinge 62 provides flexibility to allow the door 52 to pivot into the closed position when desired by the user. While shown as three separate protrusions 54, 56 and 58, the bottom of the device could be configured with a slot or channel so that a single protrusion fills the voids to provide protection to the receptacles 40, 44 and 48.

At least one of the upper portion (not shown) and the lower portion 22 may include one or more walls 74 which extend downwardly or upwardly respectively so as to engage the opposing portion. The walls 74 may engage complementary walls on the opposing portion to thereby form chambers. To help reduce the risk of contaminants getting to the components in the housing the walls may be sealed together such as by adhesive, snap fit, or by other processes such as ultrasonic welding. The walls 74 may subdivide the housing 14 into two or more compartments, as an electronic circuitry compartment 76 and a battery compartment 78. The battery compartment may 78 hold a battery 80 or similar device for storing and dispensing energy. While not required, this compartment will typically be rather large to accommodate a battery, etc. which can hold a substantial amount of energy for charging devices. Other configurations may not include subdividing walls such that the housing 14 forms a single compartment (see FIG. 9 below).

The electronic circuitry compartment 76 may hold circuitry 82 for regulating the charging and dispersal of energy from the battery 80 to and from the USB receptacles 40, 44 and 48 which may also be formed therein. The circuitry 82 may typically be disposed on a circuit board, the mounting of which will be discussed below. Thus, the wall(s) which form the second compartment will generally have a plurality of openings 40a, 44a and 48a which form part of the receptacles 40, 44, and 48, respectively.

Communication between the battery 80 and the circuitry 82 is typically accomplished by electrical leads 88 which pass through holes 90 in the wall(s) 74 which divide the battery compartment 78 from the circuitry compartment. To minimize the risk of water or other contaminants passing through the holes 90, the leads 88 may be wrapped with a coating which engages the wall(s) 74 to thereby form a seal or which is bound to the walls during sonic welding. In the alternative, a grommet 92 may be placed in the holes to allow the leads to extend therethrough while preventing or inhibiting water or other contaminants to pass into the battery compartment.

Those skilled in the art will appreciate the circuitry 82 is more likely to come into contact with water, other liquids, etc., due to the receptacles 40, 44 and 48 and the need for access thereto. To minimize the risk of damage, the circuitry may be coated with a water-proof or water resistant and/or anti-corrosive coating to prevent corrosion or other damage in the event that, for example, a drink is spilled on the portable power supply 10 while the door 52 is open. The coating may be a variety of materials and be applied through any of a number of processes, such as a parylene conformal coating, a liquid fluoropolymer coating, or chemical vapor deposition of a suitable hydrophobic substance. Additionally the coating can be made very thin (e.g. 3-30 microns) so the coating will not trap in too much heat.

In addition to providing protection against impact due to dropping the portable power supply 10, the elastomeric material 26 extending about the periphery of the housing 14 improves grip of a user's hand on the device and thereby reduces the risk of the portable power supply 10 being dropped. Likewise, the optional textured surface 24 (typically embossed) on the upper portion 18 and the lower portion 22 may improve grip and reduce the risk of the device being dropped.

Also shown in FIG. 2 is the power button 30. As was mentioned, the power button 30 may be formed as part of the elastomeric material. The power button 30 may include a projection or plunger portion 96 which extends through a hole 98 in the wall 74 to activate or deactivate the circuitry. Thus, the elastomeric material can form both the projection and the sealing mechanism, such as the annular rib 100. If needed, a more rigid material could be molded into the elastomeric material to actuate the circuitry. Other configurations for the power button 30 and plunger portion 96 are possible and contemplated herein; see, for example, the discussion of FIG. 9. Additionally, although it is referred to as the “power button,” the power button 30 may provide for other functionality on the circuitry besides powering the portable power supply on and off.

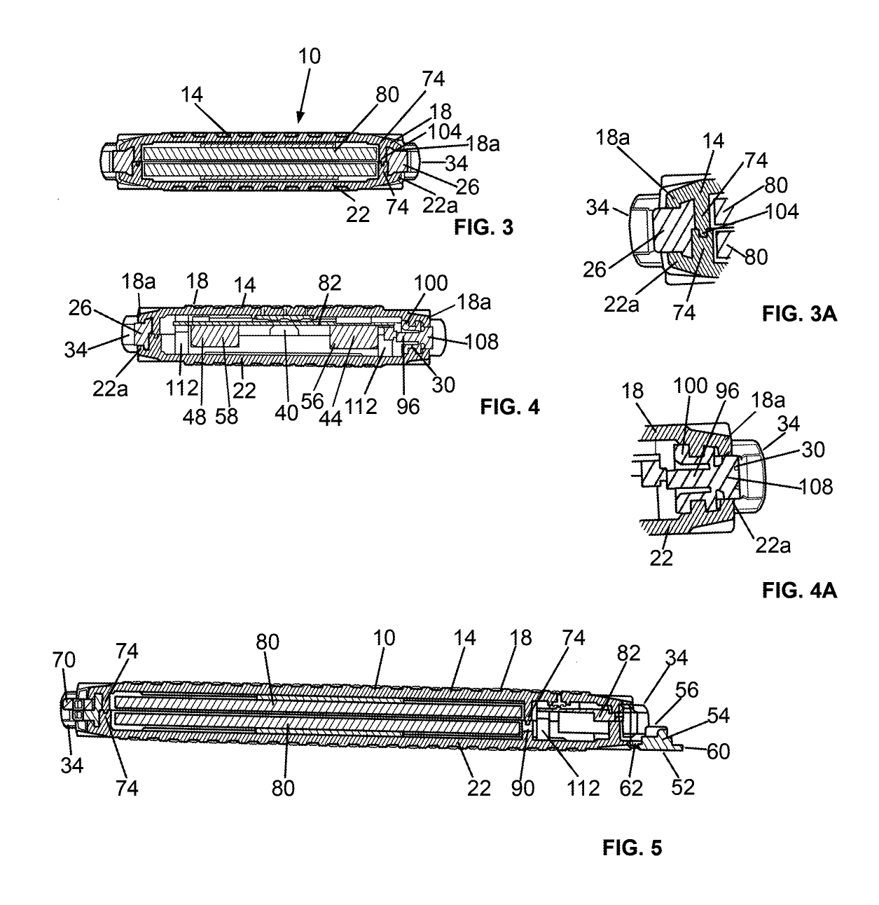

Turning now to FIG. 3, there is shown a cross-sectional view of the portable power supply 10 through the battery compartment 78 of the portable power supply 10. The battery compartment 78 may hold one or more batteries 80 or cells to provide power. The battery compartment 78 may be formed by the walls 74 extending downwardly on the upper portion 18 and upwardly on the lower portion 22. A tongue and groove attachment system 104 may be used at the engagement of the walls.

FIG. 3 also shows the elastomeric material 26 which extends inwardly from the peripheral edge 18a of the upper portion 18 and the peripheral edge 22a of the lower portion 22. If desired, the elastomeric material may butt up against the walls 74 which form the battery compartment. Between any bonding holding the walls 74 together and the tortuous path provided by the elastomeric material, the contents of the battery compartment 78 are protected against water or other liquids or contaminants which might corrode the battery.

FIG. 3A shows a close-up cross-sectional view of the elastomeric material 26 and its engagement with the edges 18a and 18b of the housing 14. The extending of the elastomeric material both inside and outside of the housing 14 makes the housing 14 more resistant to damage due to a drop and to leaking of liquids and other contaminants.

FIG. 4 shows a side-cross-sectional view of the portable power supply 10 taken through the circuitry compartment 76. It will be noted that the elastomeric material extends outwardly from the peripheral (lateral) edges of the housing 14, including the upper peripheral edge 18a and the lower peripheral edge 22a. On the right hand side of the sectional view, the elastomeric material 26 forms the power button 30. The power button 30 may include a head 108, a projection or plunger portion 96, and a seal, such as an annular rib 100 which forms a seal to inhibit the leaking of liquids, etc.

FIG. 4 also shows a circuit board 82 with a pair of mounting posts 112 for securing the electronics. As will be discussed in additional detail below, the mounting posts may be over-molded or include a damping mechanism for minimize shocks to the circuit board 82.

Also shown in FIG. 4, as the ports or receptacles 40, 44 and 48, along with a cross-section of the protrusions 56 and 58 which help seal the receptacles 44 and 48 closed when not in use.

FIG. 4A shows a close-up cross-sectional view of the elastomeric material forming the power button 30 which is numbered in accordance with the explanation in FIG. 4 above. The power button 30 may include a head 108, a projection or plunger portion 96, and a seal, such as an annular rib 100 which forms a seal to inhibit the leaking of liquids, etc. One advantage of the present invention is that the elastomeric material 26 can be molded as a single piece, including the power button and the plunger portion—both reducing cost and providing a good seal around the housing 14.

FIG. 5 shows a side cross-sectional view of the portable power supply 10 which is numbered in accordance with the description above. The sectional view shows the retaining member 70 at one end which is held in place by the elastomeric material 26, and the open door 52 which may be formed integrally with the remainder of the elastomeric material 26, and include a compliant hinge 62. The door 52 may also include a projection 60 which facilitates moving the door into the open position shown in FIG. 5.

Turning now to FIG. 6, there is shown a close-up, cross-sectional view of a circuit board 82 and mounting posts 112 in accordance with the present disclosure. The mounting post 112a shown on the left in FIG. 6 is provided with a damping member 116 made from a resilient material (which could be any suitable material, such as an elastomer, spring, etc.) which dampens the transfer of energy from the post to the circuit board 82. The other post 112 is provided with an over-mold 120 of a material which dampens the transfer of vibrational energy. Either way, the damping materials help to reduce the transfer of vibrations, such as would be caused by the housing 14 being dropped, to the components of the circuit board.

FIG. 7 shows an alternate door configuration used for closing the power ports in the housing 14. Rather than using a single door 52 as shown in FIGS. 1-6, a plurality of doors 52a, 52b, 52c are used. Like the prior embodiments, the plurality of doors can be formed from a single piece of elastomeric material. Such a configuration allows ports or receptacles which are not in use to be closed, and reduces ware on any one hinge.

It will be appreciated that the door(s) may be formed in an open position so that they are biased into an open position. In the alternative, a separation member or other structure can be used to form the hinge in a generally closed position so that it is biased toward a closed position. Also, the hinge can be of various lengths to control tension within the hinge.

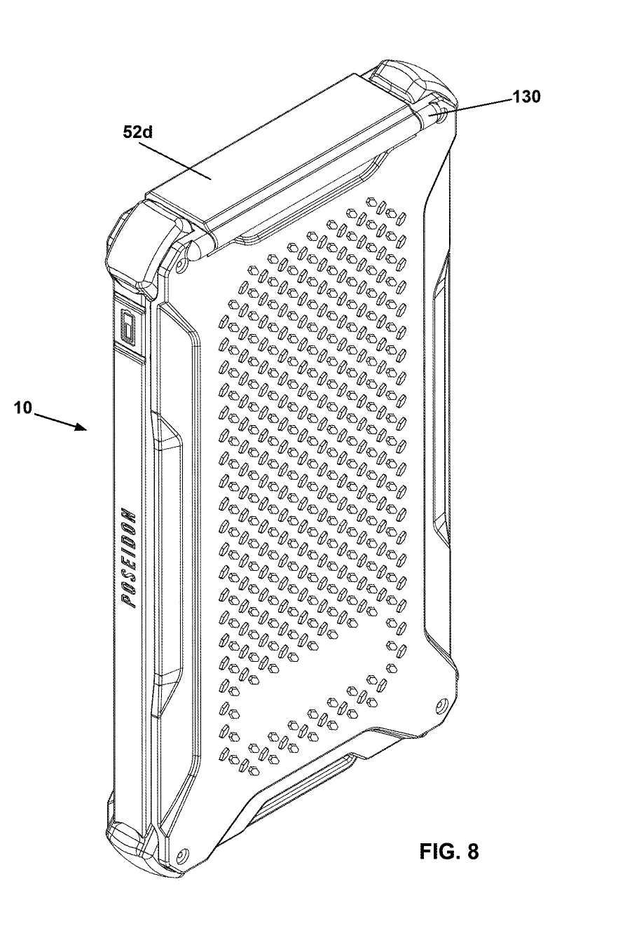

Additionally, other configurations for the door may be used. For example, FIG. 8 shows a configuration wherein the door 52d is formed of a hard plastic material. The door 52a may be opened and closed, for example, by way of a pin joint hinge 130.

FIG. 9 shows an alternate configuration wherein the upper portion 18 and the lower portion 22 of the housing 14 are connected via a snap-fit connection. FIG. 9 shows only the lower portion 22c for clarity. Any type of connection may be used, and other types of connections known in the art are contemplated. Additionally, the snap-fit connection described herein using recesses mating with protrusions is given by way of example, and other types of snap joints and connections may be used. In addition to the snap-fit connection, the lower portion 22c may also have one or more cut-away portions 132, while the upper portion 18c may have projections 134 that generally fit into, or interact with the cut-away portions 132 of the lower portion 22c of the housing. This may provide additional stability to the device and allow for shock absorption, and may limit damage to internal circuitry due to drops, etc.

Additionally, a gasket 143 may be provided. The lower portion 22c may include walls 74a that extend upwardly and the upper portion 18c may include walls 74b that extend downwardly. The gasket 143 may be placed between the walls 74b of the upper portion 18c and walls 74a of the lower portion 22c such that the upper portion 18c and lower portion 22c form a tight seal. This gasket 143 may provide protection from water, and also assist in absorbing shocks and vibrations, such as those that may occur when the portable power supply 10 may be dropped or handled roughly. The gasket 143 may be formed of one continuous piece, or more than one gasket 143 may be used.

Additionally, the elastomeric material 26 extending around the housing 14 may include one or more buttons 30a, 30b to provide for actuation of the circuitry located within the portable power supply 10. According to the configuration shown in FIG. 9, two such buttons are provided. In other configurations, one or more buttons may be provided depending on the needs of the portable power supply 10. For example, one button may be used to actuate the circuitry to determine power levels, another button may be provided to turn on a flashlight and/or SOS functions, another may turn the power supply on and off, etc. The buttons 30a,b shown in FIG. 9 may be formed of the elastomeric material 26. The elastomeric material 26 will deform when pushed so that interior structures engage the power supply to thereby actuate functions within the portable power supply 10′. The buttons 30a,b may be generally cylindrical in shape.

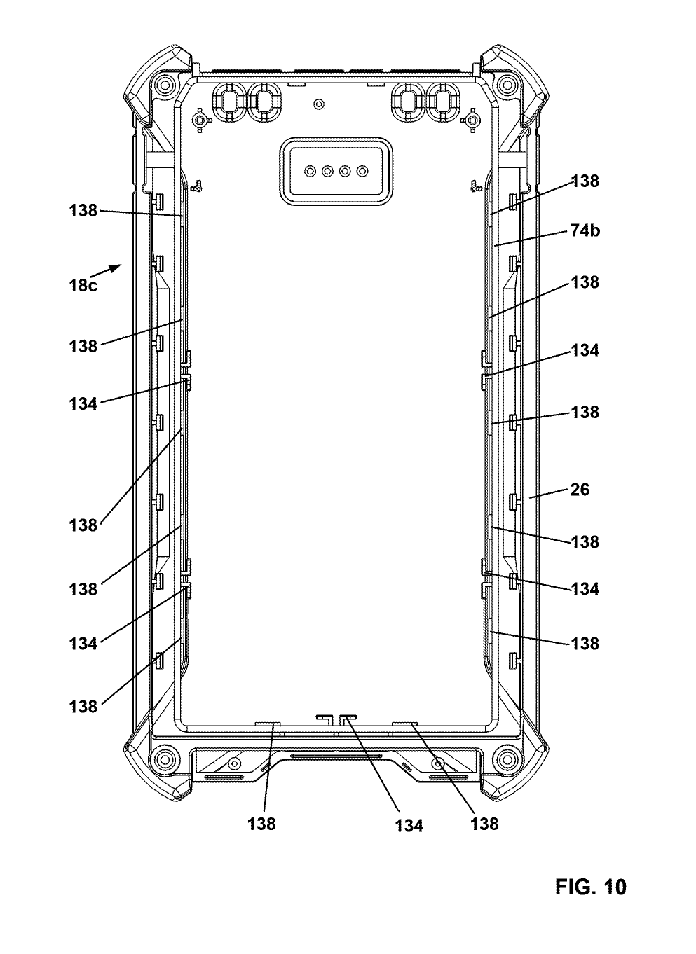

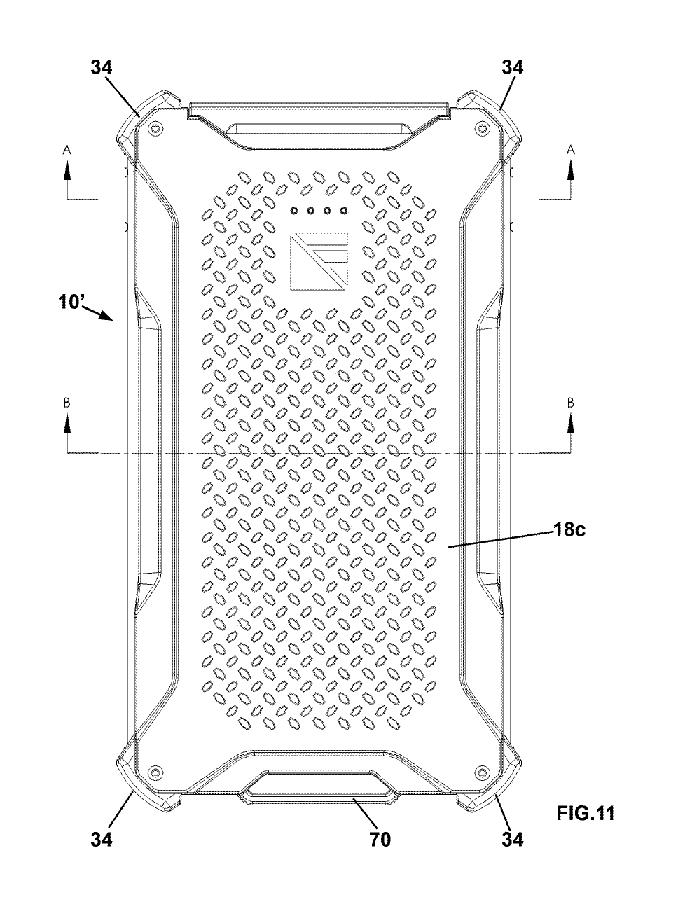

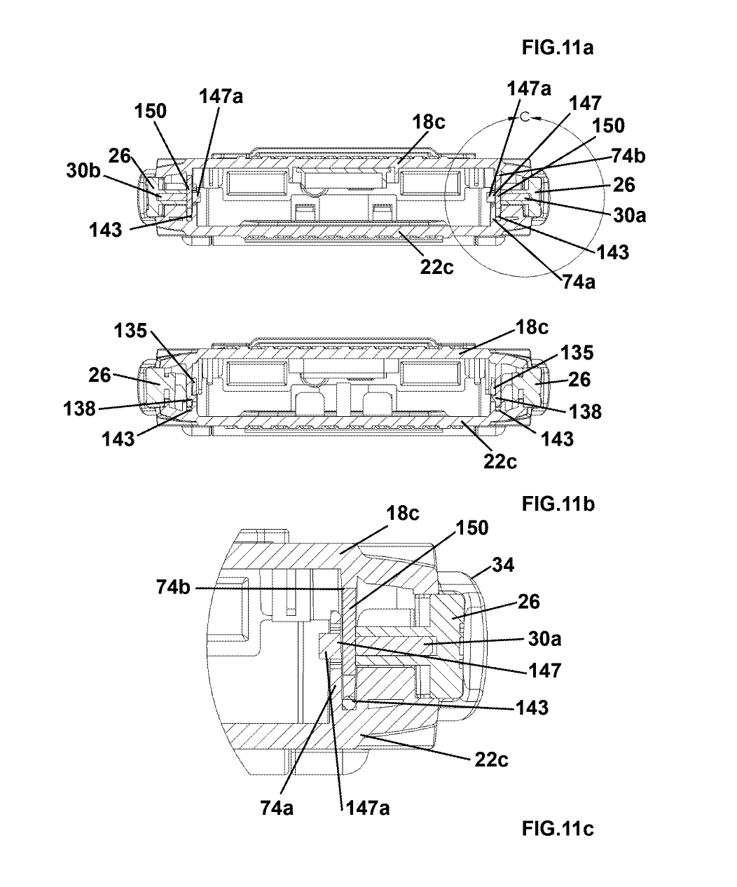

Turning now to FIG. 10 there is shown a configuration of the upper portion 18c of the housing that may be used to mate with the lower portion 22c. The lower portion 22c includes recesses 135 in the walls 74a, while the upper portion 18c may include snap-fit protrusions 138 in the walls 74b. Several protrusions 138 may be provided as shown in FIG. 10, and more snap-fit protrusions 138 or fewer may be used. The snap-fit protrusions 138 of the upper portion 18c may catch in the recesses 135 of the lower portion 22c such that the protrusions of the upper portion 18c mate with the recesses 135 of the lower portion 22c. FIG. 11B, showing a cross-sectional view of the upper portion 18c mated to the lower portion 22c, shows the snap-fit protrusions 138 of the upper portion 18c fitting into the recesses 135 of the lower portion 22c. The gasket 143 can also be seen in place between the upper portion 18c and lower portion 22c, providing sealing and/or damping functionality.

FIG. 11 shows the portable power supply 10′ with the upper portion 18c mated to the lower portion 22c. FIG. 11A shows a cross-sectional taken along line A-A of FIG. 11, showing the buttons 30a,b. FIG. 11C shows an enlarged view of the detail C in FIG. 11A. As can be seen from FIG. 11A, when depressed, the button 30a may first engage the wall 74b of the upper portion 18c, which may have an elastomeric 150 provided in the wall 74b at the approximate location the button 30a,b abuts the wall. Pressing on the elastomeric membrane 150 may in turn press on the wall 74a of the lower portion 22c, which may have a cut-out 147 provided in the wall 74a at the approximate location the button 30a, b and elastomeric membrane abut the wall of the lower portion 22c. The cut-out 147 may provide for additional inwardly motion or flexion of the wall 74a of the lower portion 22c. The cut-out 147 may also include an additional actuator portion 147a that extends into the housing 14. The actuator portion 147a may allow for easier actuation of the internal circuitry. Thus, pushing the elastomeric button 30a pushes the elastomeric membrane 150, and in turn the cut-out 147 with the actuator portion 147a, to actuate circuitry within the portable power supply 10′. FIG. 11C shows a close-up cross-sectional view of the housing with the upper portion 18c with the elastomeric membrane 150, the cut-out 147 of the lower portion 22c, and the button 30a.

Thus there is disclosed a portable power supply. Those skilled in the art will appreciate that there are numerous modifications which can be made without departing from the scope and spirit of the invention. The appended claims are intended to cover such modifications.

What is claimed is:

1. A portable power supply having housing and an elastomeric material extending about the periphery of the housing.

2. The portable power supply of claim 1, wherein the portable power supply of claim 1, wherein the housing has an upper portion having a peripheral edge and a lower portion having a peripheral edge, and wherein the elastomeric material extends inwardly and outwardly from the peripheral edge of the upper portion and the peripheral edge of the lower portion.

3. The portable power supply of claim 2, wherein the upper portion and the lower portion are connected via a snap-fit connection.

4. The portable power supply of claim 1, wherein the elastomeric material has a plurality of projections disposed at corners of the housing.

5. The portable power supply of claim 4, wherein the housing has sides and wherein the elastomeric material extends along the sides and as a first thickness, and therein the elastomeric material at the projections has a second thickness greater than the first thickness.

6. The portable power supply of claim 1, wherein the elastomeric material has at least one power button formed therein.

7. The portable power supply of claim 1, further comprising a retaining member held in place by the elastomeric material.

8. The portable power supply of claim 1, further comprising a circuit board having circuitry thereon and a water resistant layer disposed thereon over circuitry on the circuit board.

9. The portable power supply of claim 7, wherein the water resistant layer is anti-corrosive.

10. The portable power supply of claim 2, wherein the upper portion and the lower portion include at least one recess and projection for damping.

11. The portable power supply of claim 1, wherein the circuitry is connected to the battery by a plurality of leads, and wherein a sealing member is disposed about the leads in the form of a coating or a grommet.

12. The portable power supply of claim 1, wherein the housing has at least one port, and further comprising a door.

13. The portable power supply of claim 12, wherein the door includes at least one protrusion for sealing closed the at least one port.

14. A portable power supply comprising a housing containing a circuit board, the circuit board having circuitry and a water resistant coating disposed over the circuitry.

15. The portable power supply of claim 14, wherein a plurality of ports are formed in the housing adjacent to the circuit board.

16. The portable power supply of claim 15, further comprising an elastomeric door attached to the housing, the door being configured to seal the plurality of ports.

17. The portable power supply of claim 13, further comprising a piece elastomeric material extending about the periphery of the housing, the elastomeric material extending from a location inside the periphery of the housing to a location outside the periphery of the housing.

18. The portable power supply of claim 16, wherein the elastomeric material forms a power button.

19. The portable power supply of claim 16, wherein the piece of elastomeric material extends all the way around the periphery of the housing.

20. A portable power supply comprising:
a lower portion and an upper portion, the lower portion having sidewalls that extend upwardly and the upper portion having sidewalls that extend downwardly, a gasket between the sidewalls of the lower portion and the sidewalls of the upper portion, the lower portion and upper portion forming a housing with a periphery; and wherein at least one of the sidewalls of the upper portion and lower portion include an elastomeric membrane; and
an elastomeric material extending from a location inside the periphery of the housing to a location outside the periphery of the housing, the elastomeric material forming at least one button.
